(19) United States
(12) Patent Application Publication
(10) Pub. No.: US 2009/0245759 A1
(43) Pub. Date: Oct. 1, 2009

(54) TRANSMISSION AND RECEPTION APPARATUS, RECEIVER, AND REPRODUCTION METHOD

(76) Inventors: Nobutaka OKUYAMA, Yokohama (JP); Satoshi MIO, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/483,368

(22) Filed: Jun. 12, 2009

Related U.S. Application Data
(63) Continuation of application No. 10/807,238, filed on Mar. 24, 2004.

(30) Foreign Application Priority Data
Jun. 2, 2003 (JP) 2003-156124

(51) Int. Cl. H04N 7/26

(52) U.S. Cl. 386/124; 386/E05.001

(57) ABSTRACT

A reception apparatus which can link with an external device via a network, and where the external device receives and records a channel signal from broadcasted programs, including: a reception system configured to receive the channel signal from the external device; an output device configured to output the channel signal received by the reception system; and a request unit to send a request for time shift reading to the external device; wherein the external device starts time shift reading of said channel signal according to said request, and the reception system receives the channel signal time shift read and the output device outputs it.

### CROSS REFERENCE TO RELATED APPLICATION

This is a continuation of U.S. application Ser. No. 10/807,238, filed Mar. 24, 2004. This application relates to and claims priority from Japanese Patent Application No. 2003-156124, filed on Jun. 2, 2003. The entirety of the contents and subject matter of all of the above is incorporated herein by reference.

### BACKGROUND OF THE INVENTION

The present invention relates to a receiver and a reproduction method for time shift watching of a television program via a home network.

Conventionally, time shift watching and listening apparatuses for networking include a time shift watching and listening apparatus having a tuner that is networked to a time shift watching and listening apparatus having no tuner (see JP-A No. 171466/2002, for example).

Further, a conventional recording information transfer apparatus stores manipulation information about user manipulations on a recording and reproduction apparatus and transmits that information to a networked terminal (see JP-A No. 148826/2001, for example).

### SUMMARY OF THE INVENTION

In the above-mentioned JP-A No. 171466/2002, both time shift watching and listening apparatuses require that the times for time shift watching and listening be specified individually when a user moves from one apparatus to the other for continuous watching and listening. On the other hand, the apparatus described in the above-mentioned JP-A No. 148826/2001 needs to store manipulation information for network use.

In consideration for the user's convenience, it is therefore an object of the present invention to provide a method of interrupting live watching and listening of a television program on a first receiver by means of a move watching and listening function, performing time shift watching and listening on a second receiver installed at a different location, and continuing the time shift watching and listening of the interrupted television program using the second receiver with easy operations.

To achieve the above-mentioned object, the present invention can link two apparatuses via a home network. Manipulation for initiating the move watching and listening function on a current apparatus starts the recording of a program that is in the process of live watching and listening on a built-in recording medium. Upon request for time shift watching and listening from the other apparatus, the recorded program is read from the recording start point and is delivered to the other apparatus from a server.

To further achieve the above-mentioned object, the present invention can link two apparatuses via a home network. Manipulation for initiating the move watching and listening function on a current apparatus issues a recording command to the other apparatus and starts the recording of a program that is in the process of live watching and listening on a recording medium built in the other apparatus. Upon request for time shift watching and listening at the other apparatus, the recorded program is read from the recording start point in response to a command received from the current apparatus.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing the configuration of a digital video recorder home server according to embodiment 1 of the present invention;

FIG. 2 is a diagram showing the execution of tasks according to embodiment 1 of the present invention;

FIG. 3 is a diagram showing the execution of tasks according to embodiment 2 of the present invention;

FIG. 4 is a diagram showing the execution of tasks according to embodiment 3 of the present invention;

FIG. 5 is a diagram showing a manipulation menu according to the present invention;

FIG. 6 is a flowchart showing operations of a digital video recorder home server 1a according to embodiment 1 of the present invention;

FIG. 7 is a flowchart showing operations of a digital video recorder home server 1b according to embodiment 1 of the present invention;

FIG. 8 is a flowchart showing operations of a digital video recorder home server 1a according to embodiment 2 of the present invention;

FIG. 9 is a flowchart showing operations of a digital video recorder home server 1b according to embodiment 2 of the present invention;

FIG. 10 is a flowchart showing operations of a digital video recorder home server 1a according to embodiment 3 of the present invention;

FIG. 11 is a flowchart showing operations of a digital video recorder home server 1b according to embodiment 3 of the present invention; and

FIG. 12 is a diagram showing a recording and reproducing method according to the present invention.

### DETAILED DESCRIPTION OF THE PREFERRED EMBODIMENTS

### Embodiment 1

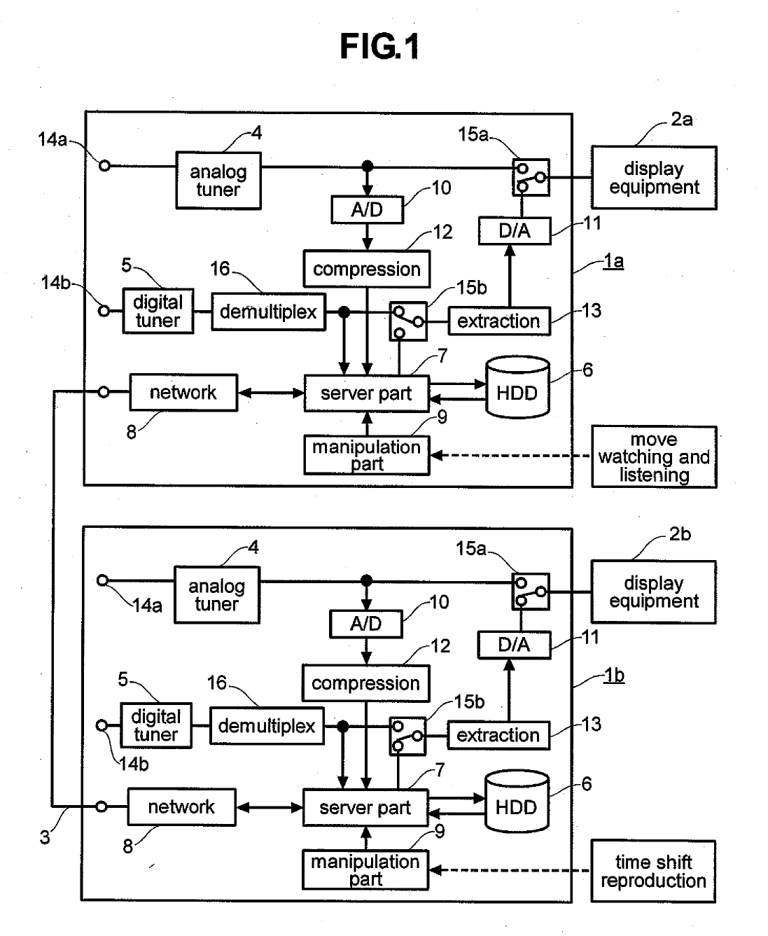

FIG. 1 is a block diagram showing the configuration of a digital video recorder home server according to embodiment 1 of the present invention. The configuration of FIG. 1 also will serve as a basis for embodiments 2 and 3 to be described later. In FIG. 1, the reference numerals 1a and 1b denote respective digital video recorder home servers having the same configuration, which servers are connected to each other via a home network 3. While the digital video recorder home server 1a (hereafter referred to as the first set) or 1b (hereafter referred to as the second set) is separated from display equipment 2a or 2b according to embodiment 1, they may be integrated therewith into a single unit.

Each of the servers 1a and 1b in FIG. 1, includes an analog tuner 4, a digital tuner 5, a hard disk drive (abbreviated as HDD in the drawings) 6 serving as a recording medium, a server part 7, a network part 8, a manipulation part 9, an A/D converter 10, a D/A converter 11, a compressor 12, a decompressor 13, an antenna terminal 14a for analog broadcast, an antenna terminal 14b for digital broadcast, signal selection switches 15a and 15b, and a demultiplexer 16.

To receive and display an analog broadcast as is, the switch 15a is selected so that the output from the analog tuner 4 is supplied directly to the display equipment 2a. To receive and display an digital broadcast as is, the demultiplexer 16 multiplexes the output from the digital tuner 5 into a plurality of channel signals (also referred to as a service). One channel signal is separated from these signals. The switch 15b is selected so that the separated signal is supplied to the decompressor 13. The output from the decompressor 13 is supplied to the D/A converter 11 and is converted into an analog signal from the digital signal. The switch 15a is selected so that the converted signal is supplied to the display equipment 2a.

To record an analog broadcast, the output from the analog tuner 4 passes through the A/D converter 10 and the compressor 12 so as to be converted into a compressed digital signal. The compressed digital signal is supplied to the server part 7 and is recorded on the hard disk 6. To record a digital broadcast, the output of the demultiplexer 16 is directly supplied to the server part 7 and is recorded on the hard disk 6.

Let us consider a case where a user operates the manipulation part 9 for initiating the move watching and listening function during live watching and listening to a broadcast program on the first set. In this case, the manipulation part 9 issues a recording instruction to the server part 7 to start recording the program that is in progress on the hard disk. Here, it is usually desirable to automatically turn off the display equipment.

Then, it is assumed that the user moves to the location where the second set is placed and operates the manipulation part 9 of the second set for effecting time shift watching and listening. The manipulation part 9 issues a request for time shift watching and listening to the first set via the server part 7, the network part 8, and the home network 3. The network part 8 of the first set transfers the request for time shift watching and listening to the server part 7. The server part 7 in the first set starts reading the program from the start point of the time shift recording and begins transmitting the recorded program to the second set via the network part 8 and the home network 3.

When the program is received by the network part 8 in the second set, the program passes through the server part 7, the decompressor 13, and the D/A converter 11, where it is converted into an analog signal, and the analog signal is reproduced and displayed on the display equipment 2b.

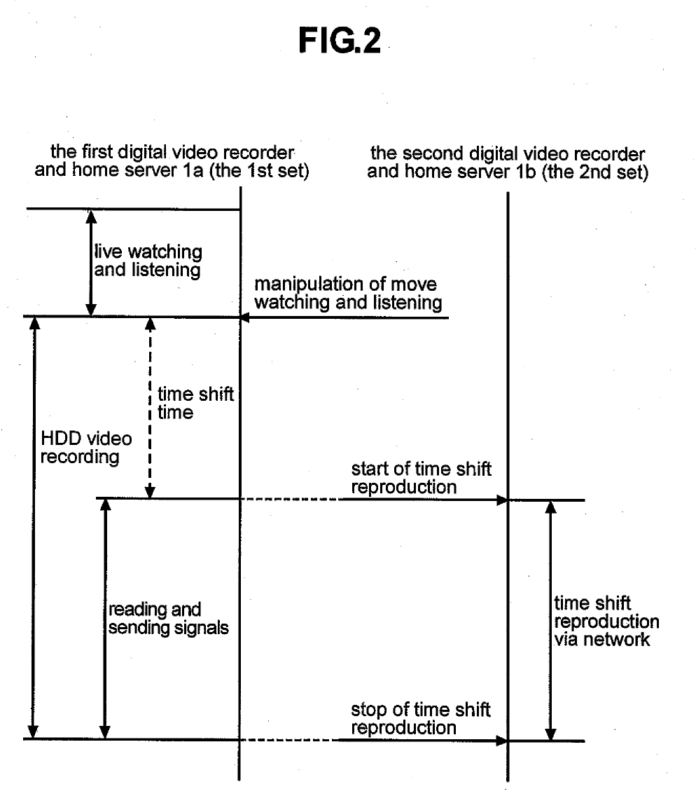

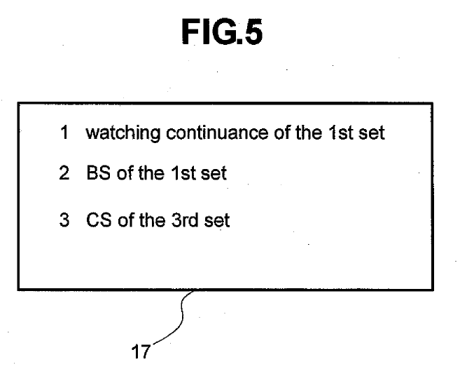

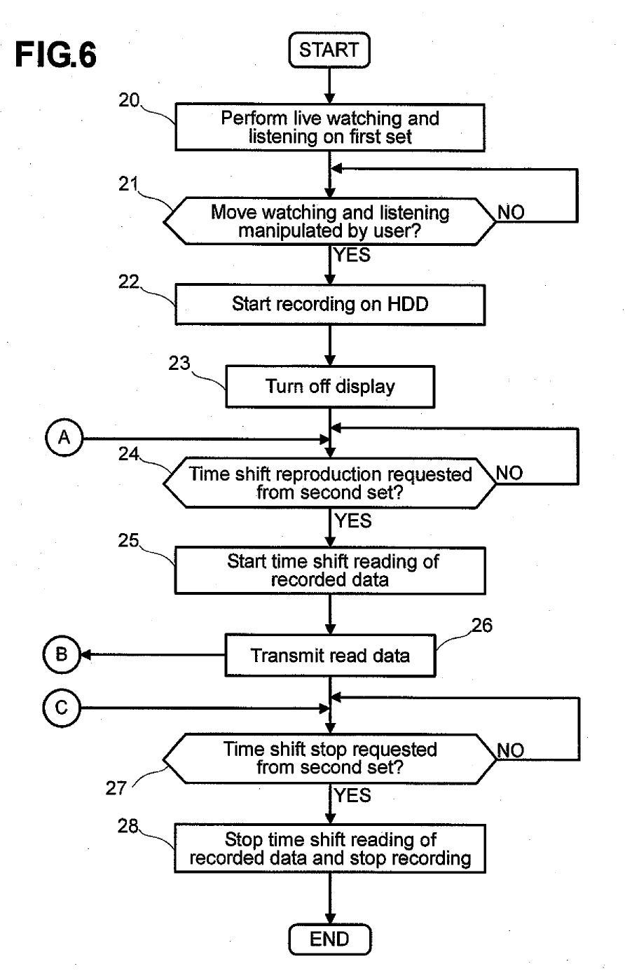

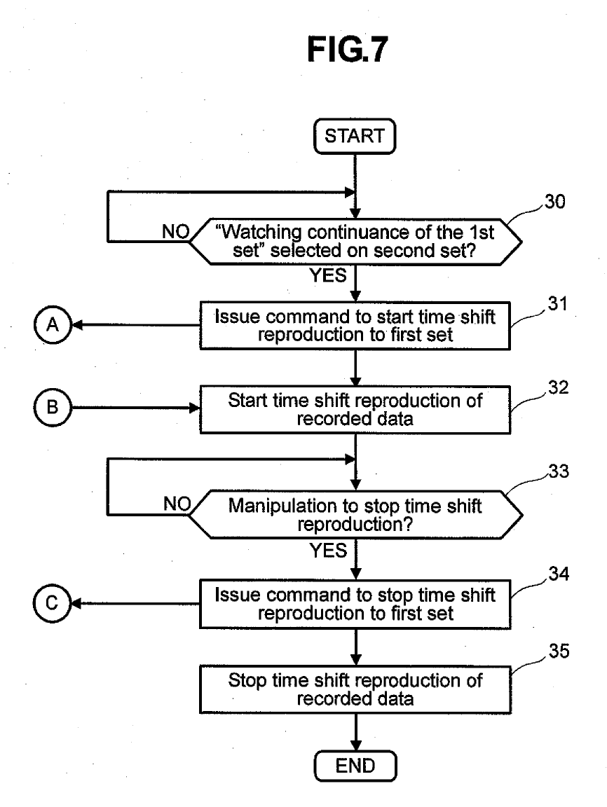

FIG. 2 is a diagram showing the execution of tasks in the first and second sets according to embodiment 1. FIG. 6 is a flowchart of operations for the first set. FIG. 7 is a flowchart of operations for the second set. A user initiates the move watching and listening function in the middle of live watching and listening of a broadcast on the first set (Steps 20 and 21). From the point in time of this manipulation, the first set starts recording the broadcast on the hard disk so as to record its recording position (Step 22). A HDD or different memory may be used to record the recording position. The user turns off the display (Step 23), moves to a room where the second set is located, and then issues a command to start the time shift watching and listening (Step 24). In this case, the user displays a manipulation menu, as seen in FIG. 5, immediately after startup of the second set, and then selects the first option “watching continuance of the first set” from the menu (Step 30). In the display example of the menu, the second option “BS of the first set” indicates that a live broadcast is to be received by communicating with a BS tuner of the first set. The third option “CS of the third set” indicates that a live broadcast is to be received by communicating with a CS tuner (not shown) connected to the home network.

The command to start the time shift watching and listening is transmitted from the second set to the first set via the home network (Step 31). The reference symbol A in the flowchart of FIG. 7 and FIG. 6 represents transmission and reception of this signal at the respective sets. In response to this signal, the first set reads the program recorded on the hard disk from the recording position corresponding to the move watching and listening manipulation (Step 25). The first set then starts delivery of the stored program to the second set (Step 26). The reference symbol B in the flowchart of FIG. 6 and FIG. 7 represents transmission and reception of the signal for the program to be delivered at the respective sets. The second set reproduces the delivered program for time shift watching and listening (Step 32). To end the watching and listening, the first set supplies the second set with a command to stop the time shift watching and listening (Step 33). The command is transmitted to the first set via the home network (Steps 34 and 27). The reference symbol C in the flowchart of FIG. 7 and FIG. 6 represents transmission and reception of the signal for the time shift stop request at the respective sets. In response to this signal, the first set stops reading and delivering the program and recording on the hard disk (Step 28). The reproduction carried out on the second set also stops (Step 35).

According to embodiment 1, a user enjoys live watching and listening to a television broadcast program halfway through the program, for example, in a room where the first set is located, and then he/she initiates the move watching and listening function to temporarily interrupt the live watching and listening. Afterward, the user moves to another room where the second set is located, and then is able to continue watching and listening to the remainder of the program from the interrupted point in a time shift manner.

The first set itself may continuously record a program in the process of live watching and listening for the purpose of time shift watching and listening. In this case, the above-mentioned feature can be applied by storing the recording position corresponding to the time point of the move watching and listening manipulation and maintaining the recording state.

### Embodiment 2

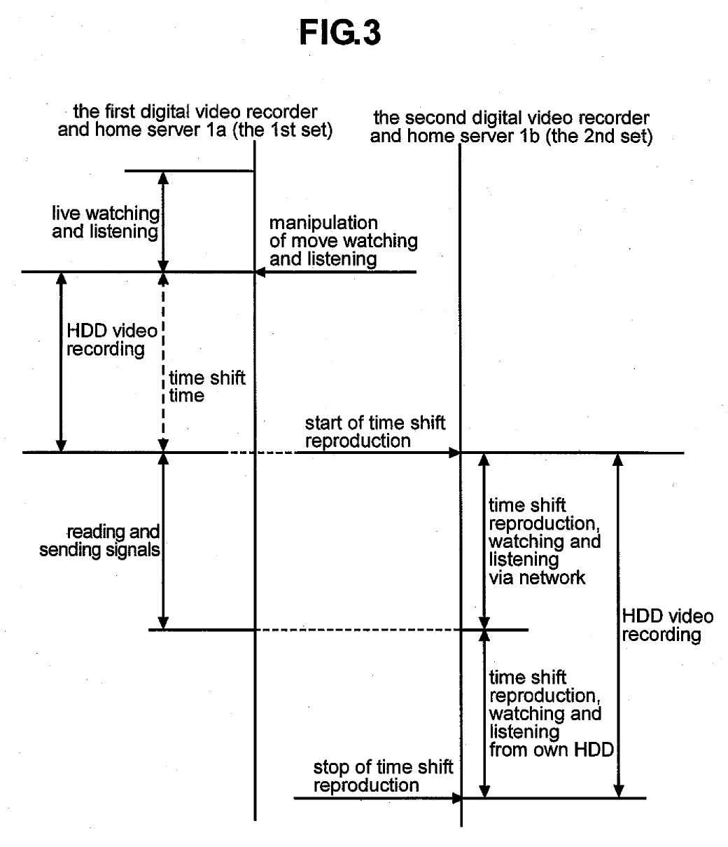

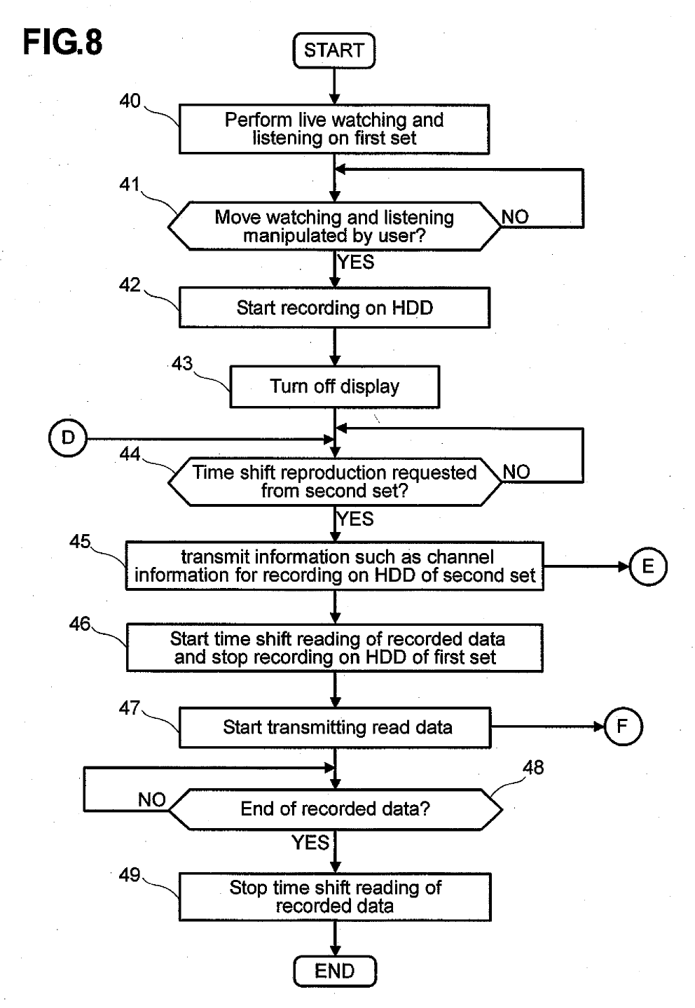

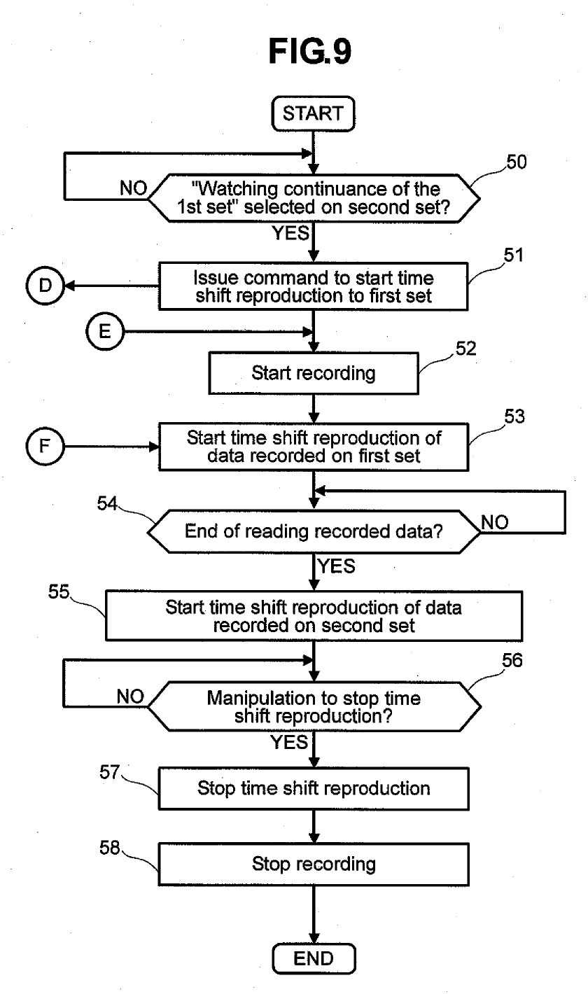

FIG. 3 is a diagram showing execution of tasks in the first and second sets according to embodiment 2. FIG. 8 is a flowchart of operations for the first set. FIG. 9 is a flowchart of operations for the second set. A user initiates the move watching and listening function in the middle of live watching and listening to a broadcast program on the first set (Steps 40 and 41). The move watching and listening manipulation starts the recording of the broadcast program for the live watching and listening on the hard disk (Step 42). The user may then turn off the display (Step 43).

The user then moves to a room where the second set is located, and issues a command to start the time shift watching and listening of the interrupted program (Step 50). This command is transmitted from the second set to the first set via the home network 3 (Step 51). The reference symbol D in the flowchart of FIG. 9 and FIG. 8 represents transmission and reception of this signal at the respective sets. In response to this signal (Step 44), the first set transmits information (channel information and the like) for recording on the second set's HDD (Step 45). The reference symbol E in the flowchart of FIG. 8 and FIG. 9 represents transmission and reception of the information, such as channel numbers for starting the second hard disk recording, at the respective sets. The first set reads the program recorded on the hard disk from the beginning and stops recording on its own HDD (Step 46). In addition, the first set transmits the read data to the second set (Step 47). Simultaneously with the start of this data delivery, the second set starts recording the program on the hard disk (Step 52). The reference symbol F in the flowchart of FIG. 8 and FIG. 9 represents transmission and reception of the signal for delivering the program recorded on the hard disk at the respective sets. In response to the delivery, the second set starts the time shift watching and listening of the recorded data from the first set (Step 53). Upon completion of transmitting and reading the program recorded on the first set is hard disk (Steps 48, 49, and 54), the user enables the time shift watching and listening from the second set's hard disk to display the program (Step 55). To end the watching and listening of the program, the user stops the time shift watching and listening (Step 56). The second set stops the time shift watching and listening and recording on the hard disk (Steps 57 and 58).

According to embodiment 2, a user enjoys live watching and listening to a television broadcast program halfway through the program, for example, in a room where the first set is located, and then issues a command for initiating the move watching and listening function to temporarily interrupt the watching and listening of the program. Afterward, the user moves to another room where the second set is located, and then continues watching and listening to the remainder of the program from the interrupted point in a time shift manner. It is also possible to finish using the first set early and allow other users to use it.

### Embodiment 3

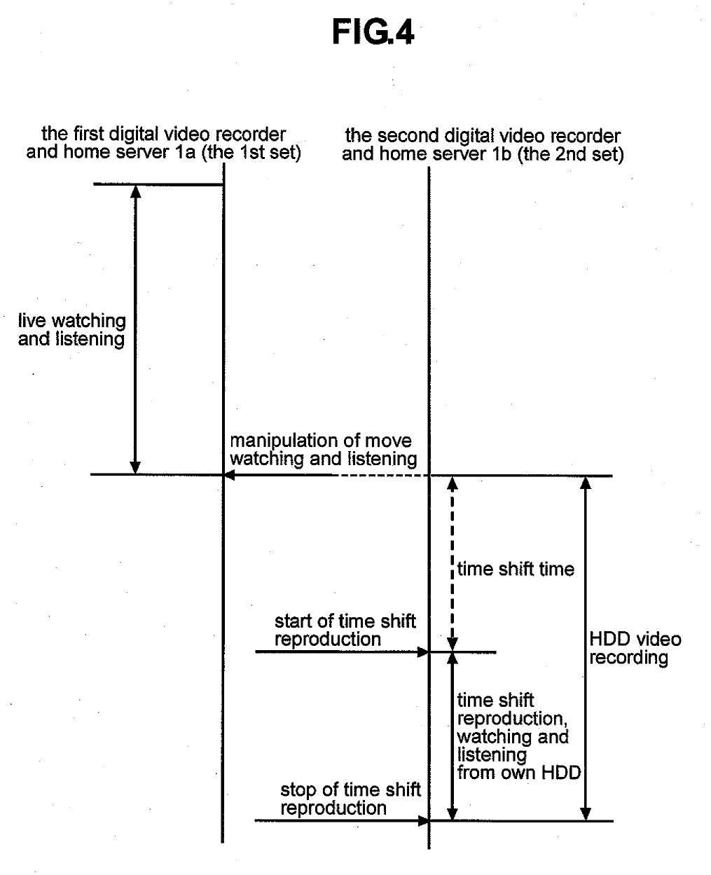

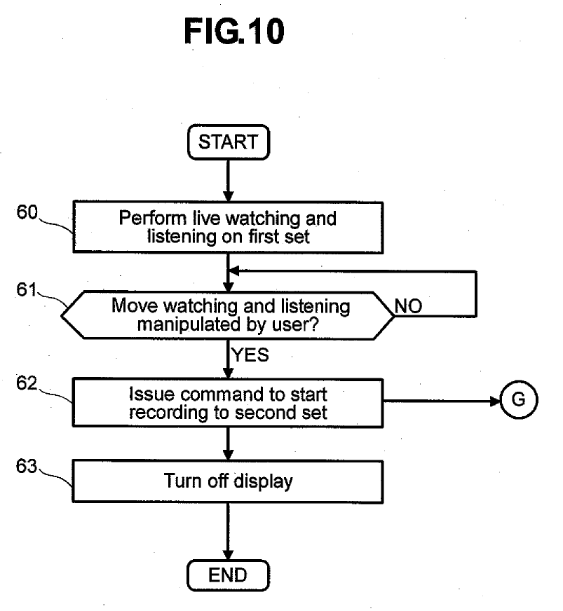

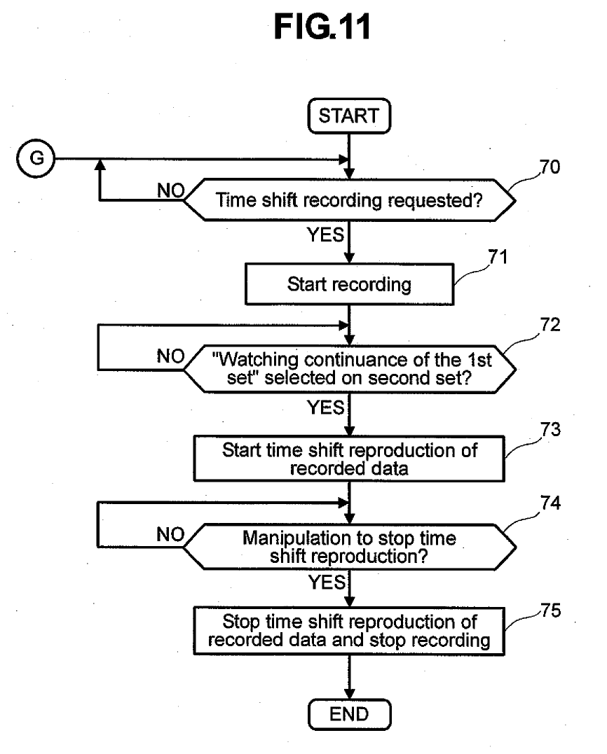

FIG. 4 is a diagram showing execution of tasks in the first and second sets according to embodiment 3. FIG. 10 is a flowchart of operations for the first set. FIG. 11 is a flowchart of operations for the second set. In the middle of live watching and listening to a broadcast program on the first set (Step 60), the user operates the manipulation part to initiate the move watching and listening function (Step 61). A signal for the manipulation is transmitted to the second set (Step 62) together with channel information for the live watching and listening via a path marked G in the flowchart. In response to the request for the time shift recording (Step 70), the second set starts recording the program that is in the process of being watched and listened to on the hard disk for time shift watching and listening (Step 71). The user turns off the first set (Step 63). The user then moves to a room where the second set is located, and then issues a command to start the time shift watching and listening of the interrupted program on the second set (Step 72). The user reads the program being recorded on the second set's hard disk from the beginning to start the time shift watching and listening at the second set (Step 73). To end the watching and listening, the user issues a command to stop the time shift watching and listening (Step 74). The second set then stops the time shift watching and listening and recording on the hard disk (Step 75).

According to embodiment 3, a user enjoys live watching and listening to a television broadcast program halfway through the program, for example, in a room where the first set is located, and then issues a command for initiating the move watching and listening function to temporarily interrupt the watching and listening at the location. Afterward, the user moves to another room where the second set is located, and then continues watching and listening to the remainder of the program from the interrupted point. It is also possible to finish using the first set immediately after issuing the command for initiating the move watching and listening function and allow other users to freely use the first set.

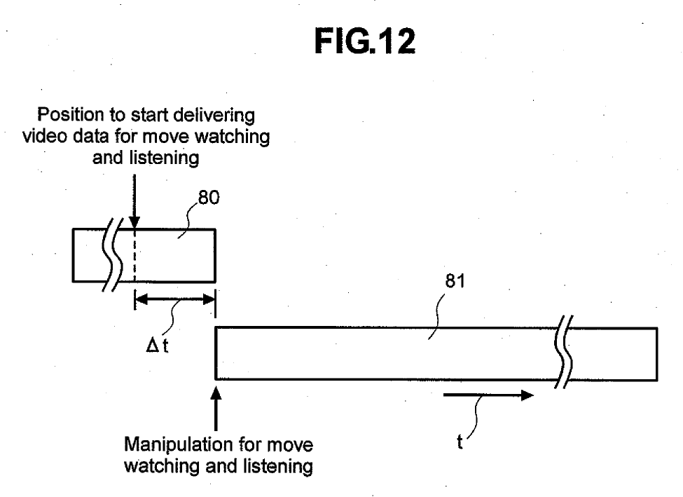

FIG. 12 is a diagram showing how to start the move watching and listening feature commonly applicable to embodiments 1 and 2 according to the present invention when a continuous recording apparatus is available. It is possible to provide a function to continuously record a specified period of a program that is being watched and listened to. In this case, video data 80, before the move watching and listening manipulation, is continuously updated and recorded in a small amount of memory or a specified storage area allocated to the HDD.

In FIG. 12, an arrow t represents the direction of time. The video data 80, before the move watching and listening manipulation, is recorded on the HDD. Accordingly, it is possible to specify a time Δt and reproduce the video data from a time point Δt prior to the time point of the move watching and listening manipulation. Thereafter, the video data 81 can be continuously delivered. In this manner, the video data for move watching and listening may be retroactively delivered for a specified period of time from the time point of the move watching and listening manipulation, instead of simultaneously with the time point thereof.

It is also possible to simultaneously provide the functions of the embodiments 1 through 3 for the corresponding servers and to allow the user to choose from the time shift watching and listening methods.

As mentioned above, the present invention provides the following effect. After live watching and listening to a television broadcast program part way through the program in a room where the first set is located, the user can issue a command for initiating the move watching and listening function to temporarily interrupt the live watching and listening at that location. The user can then move to another room where the second set is located, and continue watching and listening to the remainder of the program from the interrupted point in a time shift manner.

According to the present invention, it is possible to provide a user-friendly reproduction system.

While we have shown and described several embodiments in accordance with our invention, it should be understood that the disclosed embodiments are susceptible of changes and modifications without departing from the scope of the invention. Therefore, we do not intend to be bound by the details shown and described herein, but intend to cover all such changes and modifications as fall within the ambit of the appended claims.

What is claimed is:

1. A reception apparatus which can link with an external device via a network, and where the external device receives and records a channel signal from broadcasted programs, comprising:
a reception system configured to receive the channel signal from the external device;
an output device configured to output the channel signal received by the reception system; and
a request unit to send a request for time shift reading to the external device;
wherein the external device starts time shift reading of said channel signal according to said request,
and the reception system receives the channel signal time shift read and the output device outputs it.

2. The apparatus according to claim 1, wherein the output device outputs a manipulation menu which shows watching continuance of the external device as one option,
and the request unit sends a request for the time shift reading to the external device by a user selecting the option.

3. A reception apparatus which can link with an external device via a network, and where the external device receives and records a channel signal from broadcasted programs, comprising:
a request unit to send a request to the external device for a recorded channel signal and channel information;
a reception system configured to receive both the recorded channel signal and the channel information related to the channel signal which are transmitted by the external device according to the request;
a second reception device configured to receive a channel signal from the broadcasted programs based on the channel information related to the channel signal received by the reception system;
a recording device configured to record the channel signal received by the second reception device;
an output device configured to output the channel signal received by the reception system and then the channel signal recorded by the recording device;
wherein, after receiving the channel information from the external device, the recording device starts recording of the channel signal received by the second reception device.

4. The apparatus according to claim 3, wherein, after the reception system finishes receiving the recorded channel signal from the external device, recording device starts time shift reading of the channel signal,
and the output device outputs the channel signal time shift read.

5. The apparatus according to claim 3, wherein the output device outputs a manipulation menu which shows watching continuance of the external device as one option,
and the request unit sends a request to the external device by a user selecting the option.
